(19) United States
(12) Patent Application Publication
(10) Pub. No.: US 2006/0055967 A1
(43) Pub. Date: Mar. 16, 2006

(54) Printer, print system, and print condition setting program

(75) Inventor: Hideki Kashima, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/227,168

(22) Filed: Sep. 16, 2005

(30) Foreign Application Priority Data
Sep. 16, 2004 (JP) 2004-270058

(51) Int. Cl. G06F 3/12

(52) U.S. Cl. 358/1.15

(57) ABSTRACT

The present invention provides a printer comprising an image data reception device which receives print image data and print condition image data including an image of a print condition code corresponding to a print condition when the print image data is printed, a print condition setting device which sets the print condition by analyzing the print condition image data and a print device which prints the print image data based on the print condition set by the print condition setting device, so that the functions of a printer can be fully utilized without restrictions on the model, etc. of a shooting device.

### BACKGROUND OF THE INVENTION

1. Field of the Invention

The present invention relates to a printer, a print system, and a print condition setting program, and more specifically to a printer, etc. which is directly connected to a shooting device and performs a printing process.

2. Description of the Related Art

Recently, the technology for printing image data shot by a digital camera, etc. with a shooting device such as a digital camera, etc. connected to a printer without storing the data in a personal computer (PC), etc. has become widespread. For example, Japanese Patent Application Laid Open No. 2003-9056 discloses a digital camera having a display unit for displaying an image, a recording medium for recording the image data, an image data selection device for selecting desired image data from the recording medium, and an output method specification device for outputting the selected image data in predetermined output specifications.

Using a device for performing a printing process with a shooting device directly connected to a printer as described above, a method for setting a print condition is proposed. For example, Japanese Patent Application Laid Open No. 2003-175657 discloses a printer for selecting a desired print condition file from a memory card storing a plurality of print condition files and setting a print condition based on the print condition file and the hardware specifications of a printer. Additionally, Japanese Patent Application Laid Open No. 2004-15234 discloses a print device for setting a print condition by notifying a digital camera of the function of the printer in a script described in a text format when an image stored in a digital camera is printed with the digital camera directly connected to the printer.

### SUMMARY OF THE INVENTION

Conventionally, in a device for performing a printing process with a shooting device directly connected to a printer, a print condition is set in a predetermined sequence between the shooting device and the printer, and it is necessary to reserve the compatibility between various models of shooting devices and the connected printer. Therefore, the setting items (print conditions) in a printing process are restricted to common items to various shooting devices and printers, and the functions of a printer cannot be fully utilized.

When a memory card is lost in the printer disclosed by Japanese Patent Application Laid Open No. 2003-175657, there has been the problem that print conditions cannot be set.

The present invention has been developed to solve the above-mentioned problems, and aims at providing a printer, a print system, and a print condition setting program capable of easily setting a complicated print condition independent of the model, etc. of a shooting device.

To attain the above-mentioned objective, the printer according to the first aspect of the present invention includes: an image data reception device which receives print image data and print condition image data including an image of a print condition code corresponding to a print condition when the print image data is printed; a print condition setting device which sets the print condition by analyzing the print condition image data; and a print device which prints the print image data based on the print condition set by the print condition setting device.

With the printer according to the first aspect, a complicated print condition can be set only by receiving print condition image data together with print image data. When a printing process is performed with a shooting device directly connected to a printer, the complicated print condition can be easily set without restrictions on the model, etc. of a shooting device.

The printer according to the second aspect of the present invention is based on the first aspect, and the print device prints a print condition code table describing a print condition of the print image data and a print condition code corresponding to the print condition.

With the printer according to the second aspect, a print condition can be set without fail even when a print condition code table required to set a print condition code is lost, etc.

The printer according to the third aspect of the present invention is based on the first or second aspect, and the print condition image data is at least one of a one-dimensional bar code, a two-dimensional bar code, a character, a picture, and a mark which can be analyzed by the print condition setting device.

The printer according to the fourth aspect of the present invention is based on the first to third aspects, and the print condition is at least one of a type of print service, a print size, a type of template applied to the print image data, a rotation direction, a type of printing paper, a number of printed copies, and coordinates indicating a trimming position.

The print system according to the fifth aspect of the present invention includes: a shooting device which shoots an image; a printer which prints print image data shot by the shooting device; and a print condition code table on which a print condition when the print image data is printed and a print condition code corresponding to the print condition are printed. With the configuration, the shooting device comprises: a print condition image data generation device which generates print condition image data including an image of a print condition code when the print condition code printed on the print condition code table is shot; and a transmission device which transmits the print condition image data to the printer; and the printer comprises: an image data reception device which receives the print image data and the print condition image data; a print condition setting device which sets the print condition by analyzing the print condition image data; and a print device which prints the print image data according to the print condition set by the print condition setting device.

With the print system according to the fifth aspect, a complicated print condition can be easily set only by transmitting an image of a print condition code shot by a shooting device to a printer. Since the printer according to the present invention can set a print condition independent of the type, etc. of a connected shooting device, the functions of a printer can be fully utilized.

The print condition setting program according to the sixth aspect of the present invention is used to direct a computer in a printer to realize the functions of: receiving print image data; receiving print condition image data including an image of a print condition code corresponding to a print condition when the print image data is printed; setting the print condition by analyzing the print condition image data; and printing the print image data according to the set print condition.

According to the present invention, a complicated print condition can be easily set only by transmitting an image of a print condition code shot by a shooting device to a printer. Since the printer according to the present invention can set a print condition independent of the type, etc. of a connected shooting device, the functions of a printer can be fully utilized.

### BRIEF DESCRIPTION OF THE DRAWINGS

FIG. 1 is a schematic chart of a print system according to an embodiment of the present invention;

FIG. 2 is a block diagram of the internal configuration of a digital camera 12;

FIG. 3 is a block diagram of the internal configuration of a printer 14;

FIG. 4 shows an example of a print condition;

FIG. 5 shows an example of a print condition code; and

FIG. 6 is a sequence of the printing process performed by a print system 10.

### DETAILED DESCRIPTION OF THE PREFERRED EMBODIMENTS

The printer, the print system, and the print condition setting program according to the present invention are explained below by referring to the attached drawings.

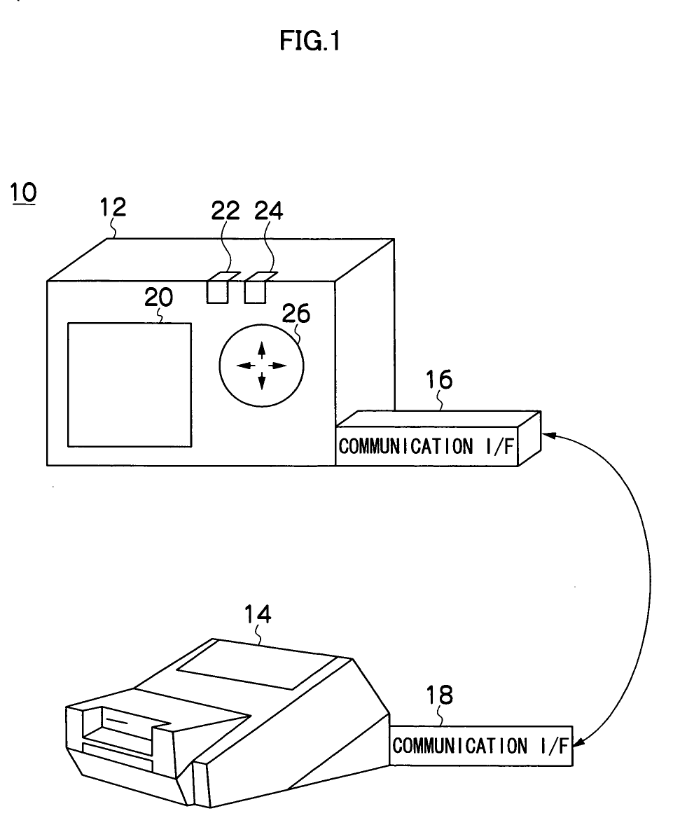

FIG. 1 is a schematic chart of a print system according to an embodiment of the present invention. A print system 10 shown in FIG. 1 comprises a shooting device (digital camera) 12 and a printer 14. The shooting device 12 can be a mobile telephone with a camera, etc.

As shown in FIG. 1, the digital camera 12 and the printer 14 are connected through respective communication I/F 16 and 18, and image data is directly transmitted from the digital camera 12 to the printer 14, and a printing process is performed. The method of connecting the digital camera 12 to the printer 14 can be a method using a cable interface such as a USB, an IEEE 1394, etc., and a method using a radio interface such as an IrDA, etc.

As shown in FIG. 1, the digital camera 12 is provided with a monitor 20, a regeneration button 22, a release button 24, and a cross button 26.

The monitor 20 can be used as an electronic finder for checking the angle of view when a shooting operation is performed, and a preview image of a shot image, a regenerated image read from the memory card inserted into the digital camera 12, etc. can be displayed.

The regeneration button 22 is an operation unit which changes the mode of the digital camera 12. When a user presses the regeneration button 22, the mode of the digital camera 12 is switched from the shooting mode in which an image is shot to the regeneration mode in which the image data shot by the digital camera 12 is read from a memory card and displayed on the monitor 20.

The cross button 26 is a multifunction operation unit capable of inputting a directive in four directions, that is, upward, downward, left, and right. The left and right keys respectively function as a one-frame reverse button and a one-frame advance button in the regeneration mode. The up and down keys function as zoom keys, etc. for adjustment of a factor in a regeneration zoom function and an electronic zoom function during shooting.

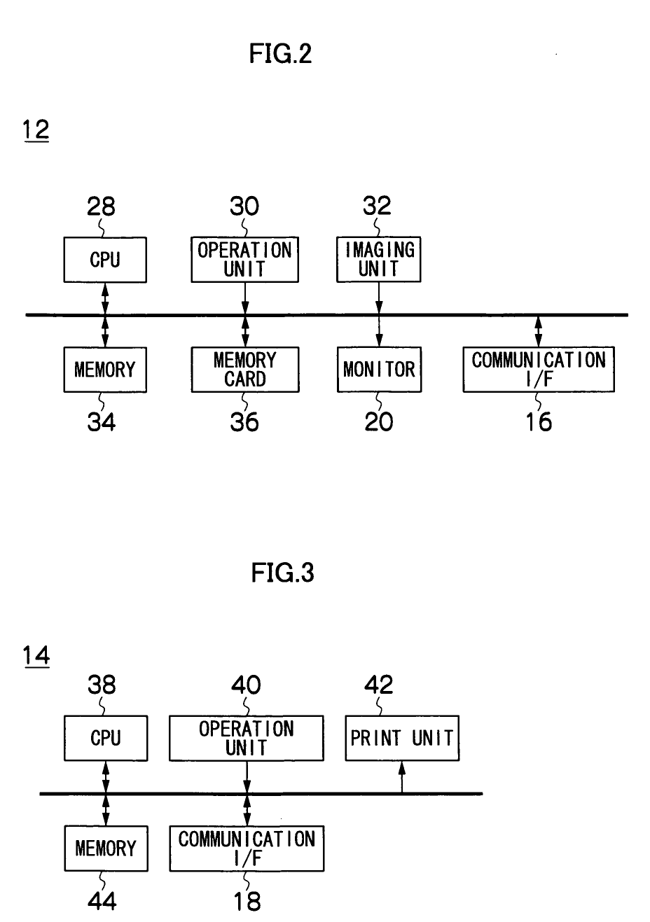

FIG. 2 is a block diagram of an internal configuration of the digital camera 12. As shown in FIG. 2, the digital camera 12 comprises a CPU 28, an operation unit 30, an imaging unit 32, memory 34, and a memory card 36.

The CPU 28 is a control unit for integrally controlling the digital camera 12. The CPU 28 controls the operation of each circuit in the digital camera 12 according to an input directive signal from the regeneration button 22, the release button 24, the cross button 26, etc.

The operation unit 30 is a block including the above-mentioned operation input devices such as the regeneration button 22, the release button 24, the cross button 26, etc.

The imaging unit 32 is a block including an optical system and an imaging device for forming an image of a subject, a processing unit for converting the image formed by the image forming device to digital data.

The memory 34 includes ROM for storing a program processed by the CPU 28, various data required for control, etc. and RAM containing a temporary storage area storing image data obtained by the imaging unit 32, an image process area in which image data is processed, a work area in which the CPU 28 performs various arithmetic operations, etc.

The memory card 36 stores image data obtained by the imaging unit 32 in a predetermined format, and can be, for example, an xD picture card, a CompactFlash (CF) card (registered trademark), etc.

FIG. 3 is a block diagram of the internal configuration of the printer 14. As shown in FIG. 3, the printer 14 comprises a CPU 38, an operation unit 40, a print unit 42, and memory 44.

The CPU 38 is a control unit for integrally controlling the operation of each circuit in the printer 14 according to a directive signal from the digital camera 12, etc. which is input through the operation unit 40 and the communication I/F 18. The CPU 38 analyzed the print condition image data received from the digital camera 12, and sets a print condition.

The operation unit 40 is a block including a power button of the printer 14 and an operation input device such as a reset button, etc.

The print unit 42 is a device for printing image data received from the digital camera 12 according to the print condition set by the CPU 38.

The memory 44 includes ROM for storing a program processed by the CPU 38, various data required for control, etc. and RAM containing a temporary storage area storing image data received from the digital camera 12, an image process area in which image data is processed, a work area in which the CPU 38 performs various arithmetic operations, etc. The memory 44 stores a print condition code table described later, image data of a template for combination with image data, etc.

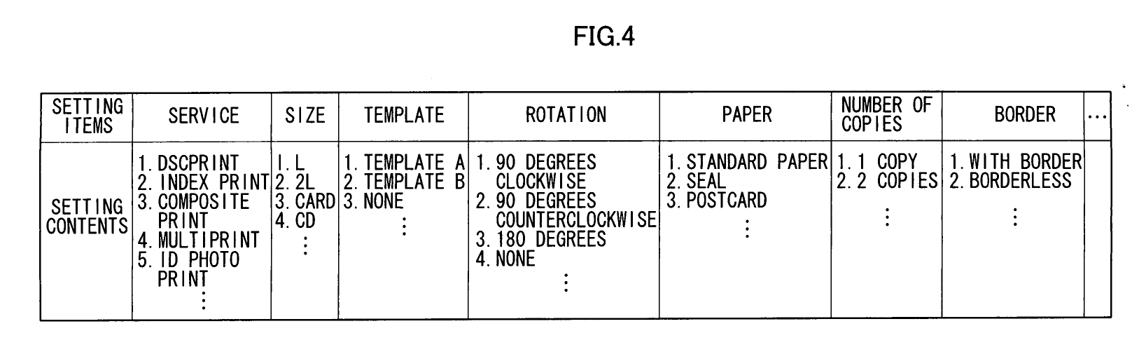

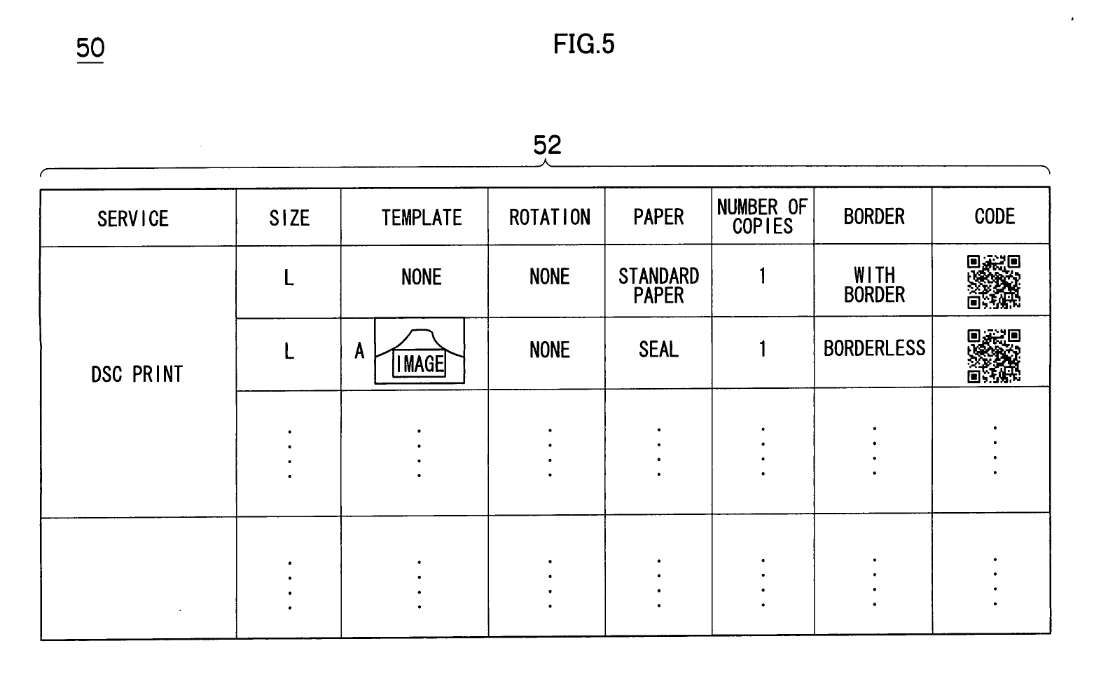

Next, the method of setting a print condition by the print system 10 is explained below by referring to FIGS. 4 and 5.

FIG. 4 shows an example of a print condition. On the table shown in FIG. 4, setting items (service, size, etc.) of a print condition and setting contents are shown, and each setting content is assigned a number. The setting items and setting contents are not limited to those in the example shown in FIG. 4.

In the present embodiment, a print condition is coded using a combination of the numbers. For example, if a service is a composite print (number 3) for combining image data with a template and performing a printing process, the print size is an L size (number 1), the type of template to be combined with print image data is a template A (number 1), the rotation direction of print image data is 90 degrees (number 1), the type of printing paper is a standard type (number 1), and the number of printed copies is one (number 1), then the print condition is expressed by a sequence “311111”. Next, the “311111” is coded and a print condition code is generated.

FIG. 5 shows an example of a print condition code. A print condition code table 50 shown in FIG. 5 is a table in which a print condition 52 is associated with a print condition code (QR code) 54. In the column of the template of the print condition 52, an image of a template to be combined with image data is printed.

The print condition code table 50 can be printed on the printer 14. Therefore, for example, when the print condition code table 50 is lost, it can be image obtained, and the print condition can be set without fail. The print condition code table 50 can be put in a package as a printed article when the printer 14 is put for sale.

In FIG. 5, the print condition code 54 is a QR code, but it can also be a one-dimensional bar code, a two-dimensional bar code, a character, a picture, a mark, etc. that can be analyzed by the printer 14.

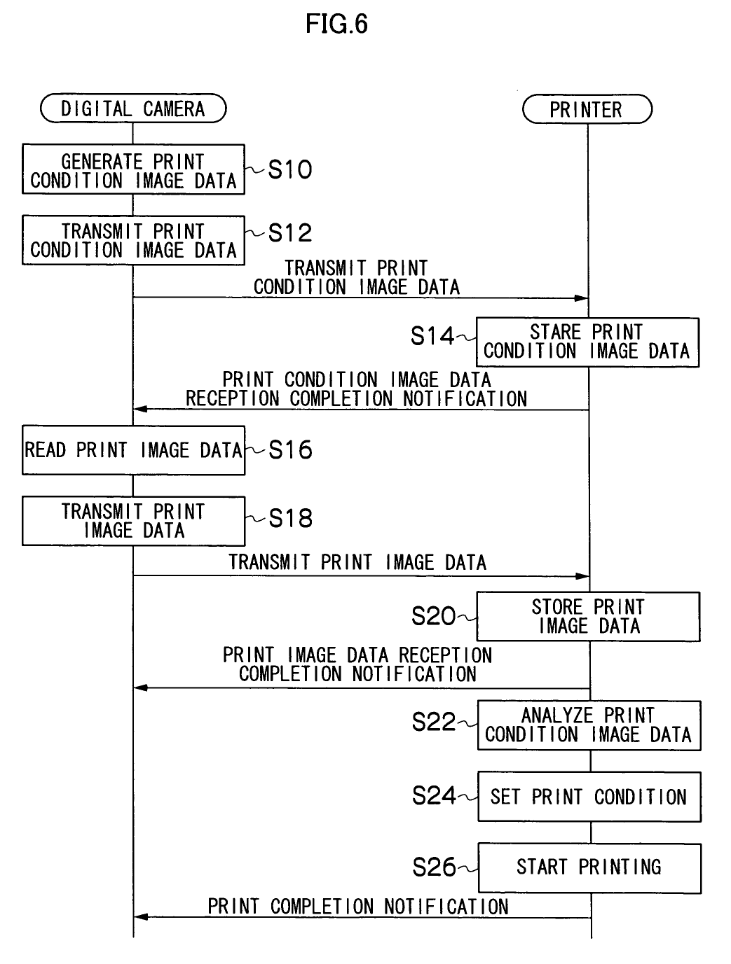

Next, the printing process performed by the print system 10 is explained below by referring to FIG. 6.

FIG. 6 is a sequence showing a printing process performed by the print system 10.

First, a user selects a desired print condition 52 from the print condition code table 50, and the print condition code 54 corresponding to the selected print condition 52 is shot by the digital camera 12, thereby generating print condition image data (step S10). Next, the print condition image data is transmitted to the printer 14 (step S12), and is stored in the memory 44 of the printer 14 (step S14). Thus, a print condition image data reception completion notification is transmitted to the digital camera 12.

Next, in the digital camera 12, a user desired image data (print image data) is read from the memory card 36 (step S16), and is transmitted to the printer 14 (step S18). Then, the print image data is stored in the memory 44 of the printer 14 (step S20), and a print image data reception completion notification is transmitted to the digital camera 12.

Then, in the printer 14, the print condition image data is analyzed (step S22), and the print condition is set (step S24). Then, according to the print condition set in step S24, printing the print image data is started (step S26). When the printing is completed, a print completion notification is transmitted from the printer 14 to the digital camera 12.

When plural pieces of print image data are to be printed under different print conditions, the print conditions are changed by transmitting new print condition image data from the digital camera 12 to the printer 14.

According to the present embodiment, a print condition can be automatically set by the printer 14 only by shooting and transmitting the print condition code 54. Therefore, a complicated print condition can be easily set. In addition, in the print system 10, the digital camera 12 only shoots the print condition code 54 and transmits print condition image data and print image data. Therefore, the printer 14 according to the present invention can set the print condition independent on the model, etc. of the connected digital camera 12, thereby fully utilizing the function of the printer 14.

According to the present embodiment, the print condition code 54 is not shot each time a printing process is performed, but the print condition code 54 is shot by the digital camera 12 in advance, and print condition image data can be stored. In this case, for example, the monitor 20 of the digital camera 12 displays print condition image data, the data is compared with the print condition code table 50, the print condition image data corresponding to desired print condition 52 is selected and transmitted to the printer 14, thereby setting the print condition similarly as described above.

The print system 10 according to the present embodiment can be provided as a printer, or a combination of a printer and a digital camera. For example, it can also be provided as an update program for firmware of an existing printer.

What is claimed is:

1. A printer, comprising:
an image data reception device which receives print image data and print condition image data including an image of a print condition code corresponding to a print condition when the print image data is printed;
a print condition setting device which sets the print condition by analyzing the print condition image data; and
a print device which prints the print image data according to the print condition set by the print condition setting device.

2. The printer according to claim 1, wherein
the print device prints a print condition code table describing:
a print condition of the print image data; and
a print condition code corresponding to the print condition.

3. The printer according to claim 1, wherein
the print condition image data is at least one of a one-dimensional bar code, a two-dimensional bar code, a character, a picture, and a mark which can be analyzed by the print condition setting device.

4. The printer according to claim 2, wherein
the print condition image data is at least one of a one-dimensional bar code, a two-dimensional bar code, a character, a picture, and a mark which can be analyzed by the print condition setting device.

5. The printer according to claim 1, wherein
the print condition is at least one of a type of print service, a print size, a type of template applied to the print image data, a rotation direction, a type of printing paper, a number of printed copies, and coordinates indicating a trimming position.

6. The printer according to claim 2, wherein
the print condition is at least one of a type of print service, a print size, a type of template applied to the print image data, a rotation direction, a type of printing paper, a number of printed copies, and coordinates indicating a trimming position.

7. The printer according to claim 3, wherein
the print condition is at least one of a type of print service, a print size, a type of template applied to the print image data, a rotation direction, a type of printing paper, a number of printed copies, and coordinates indicating a trimming position.

8. The printer according to claim 4, wherein
the print condition is at least one of a type of print service, a print size, a type of template applied to the print image data, a rotation direction, a type of printing paper, a number of printed copies, and coordinates indicating a trimming position.

9. A print system, comprising:
a shooting device which shoots an image;
a printer which prints print image data shot by the shooting device; and
a print condition code table on which a print condition of the print image data and a print condition code corresponding to the print condition are printed, wherein:
the shooting device comprises:
a print condition image data generation device which generates print condition image data including an image of a print condition code when the print condition code printed on the print condition code table is shot; and
a transmission device which transmits the print condition image data to the printer; and
the printer comprises:
an image data reception device which receives the print image data and the print condition image data;
a print condition setting device which sets the print condition by analyzing the print condition image data; and
a print device which prints the print image data according to the print condition set by the print condition setting device.

10. A print condition setting program used to direct a computer in a printer to realize the functions of:
receiving print image data;
receiving print condition image data including an image of a print condition code corresponding to a print condition when the print image data is printed;
setting the print condition by analyzing the print condition image data; and
printing the print image data according to the set print condition.
